(19) United States
(12) Patent Application Publication
(10) Pub. No.: US 2013/0332828 A1
(43) Pub. Date: Dec. 12, 2013

(54) AUXILIARY METHOD AND DEVICE IN INFORMATION CONFIGURATION PROCESS

(71) Applicant: HUAWEI TECHNOLOGIES CO., LTD., Shenzhen (CN)

(72) Inventors: Wanqing NAN, Shenzhen (CN); Changhao Wang, Shenzhen (CN)

(73) Assignee: HUAWEI TECHNOLOGIES CO., LTD., Shenzhen (CN)

(21) Appl. No.: 13/800,507

(22) Filed: Mar. 13, 2013

Related U.S. Application Data
(63) Continuation of application No. PCT/CN2011/072703, filed on Apr. 13, 2011.

(51) Int. Cl. G06F 3/048

(52) U.S. Cl. CPC G06F 3/048
USPC 715/708

(57) ABSTRACT

An auxiliary method and an auxiliary device in an information configuration process are provided. The auxiliary method in an information configuration process includes: reading an input item to be configured and an input value corresponding to the input item in a configuration interface; searching for a help information template and an input value transform rule which are corresponding to the input item; transforming the input value according to the input value transform rule; generating help information for the input item by using the help information template and the transformed input value; and displaying the help information in the configuration interface. The present invention further provides an auxiliary device in an information configuration process. Embodiments of the present invention help to improve efficiency of information configuration.

### CROSS-REFERENCE TO THE RELATED APPLICATION

This application is a continuation of International Application No. PCT/CN2011/072703, filed on Apr. 13, 2011, which is hereby incorporated by reference in its entirety.

### FIELD OF THE INVENTION

The present invention relates to the technical field of information configuration, and in particular, to an auxiliary method and an auxiliary device in an information configuration process.

### BACKGROUND OF THE INVENTION

In some large software systems, some information usually needs to be configured to enable the systems to run according to the configured information. For example, in the field of telecommunications, some telecommunication charging information often needs to be configured. At this time, a configuration interface needs to be provided to a user, and each input item needing to be configured displays in the interface.

However, whether a configuration interface of an existing software system is easy to be understood by configuration personnel is not considered in design of the configuration interface. For example, in a configuration interface shown in FIG. 1, a field name of each input item is represented by English words or phrases. Configuration personnel who do not know the configuration interface well may not understand meaning of each input item, resulting in the error occurring in an information configuration process and even the failure in the information configuration.

Definitely, a common software system may provide help information. When encountering a comprehension difficulty in the information configuration process, the configuration personnel may search for a solution to the problem in the help information. However, the help information is usually the combination of numerous pieces of information which are fragmented and static. The configuration personnel need to manually find information related to the configuration interface from the numerous pieces of information and organize the found information, which is difficult and inefficient. Moreover, for both online and local help, interfaces for displaying help information are separated from the configuration interface. Therefore, the configuration personnel need to frequently switch between different interfaces, resulting in low efficiency in the information configuration process.

### SUMMARY OF THE INVENTION

The present invention provides an auxiliary method and an auxiliary device in an information configuration process, which help to improve efficiency of information configuration.

The present invention provides the following solutions.

An auxiliary method in an information configuration process includes:
reading an input item to be configured and an input value corresponding to input item in a configuration interface;
searching for a help information template and an input value transform rule which are corresponding to the input item;
transforming the input value according to the input value transform rule;
generating help information for the input item by using the help information template and the transformed input value; and
displaying the help information in the configuration interface.
An auxiliary method in an information configuration process includes:
reading at least two input items and their respective input values in a configuration interface;
for each input item and an input value corresponding to the input item, searching for a help information template, an input value transform rule, and a sequence number, which correspond to the input item; transforming the corresponding input value according to the found transform rule; and generating help information for the input item by using the help information template and the transformed input value;
combining help information corresponding to the input items according to sequence numbers corresponding to the input items and generating help information for the configuration interface; and
displaying the help information of the configuration interface in the configuration interface.

An auxiliary device in an information configuration process includes:
a reading unit, configured to read an input item to be configured and an input value corresponding to the input item in a configuration interface;
a searching unit, configured to search for a help information template and an input value transform rule which are corresponding to the input item;
a transforming unit, configured to transform the input value according to the input value transform rule;
a generating unit, configured to generate help information for the input item by using the help information template and the transformed input value; and
a displaying unit, configured to display the help information in the configuration interface.

An auxiliary device in an information configuration process includes:
a reading unit, configured to read at least two input items and their respective input values in a configuration interface;
a first generating unit, configured to, for each input item and an input value corresponding to the input item, search for a help information template, an input value transform rule, and a sequence number, which correspond to the input item; transform the corresponding input value according to the found transform rule; and generate help information for the input item by using the help information template and the transformed input value;
a second generating unit, configured to combine help information corresponding to the input items according to sequence numbers corresponding to the input items and generate help information for the configuration interface; and
a displaying unit, configured to display the help information of the configuration interface in the configuration interface.

According to the embodiments of the present invention, the present invention discloses the following technical effects:
in the embodiments of the present invention, by using a help information template and an input value transform rule, an input item and an input value thereof in the configuration interface are transformed into help information, and the help information obtained by transformation is directly displayed in a configuration interface. In this way, the input item and the input value thereof can be explained through the help information displayed in the configuration interface, so that configuration personnel can intuitively understand meaning of each input item and an input value thereof and do not need to switch to a help interface to search for help information, which helps to improve efficiency of information configuration.

### BRIEF DESCRIPTION OF THE DRAWINGS

To illustrate the technical solutions in the embodiments of the present invention or in the prior art more clearly, the following briefly describes the accompanying drawings required for describing the embodiments. Apparently, the accompanying drawings in the following description merely show some embodiments of the present invention, and persons of ordinary skill in the art can derive other drawings from these accompanying drawings without creative efforts.

FIG. 1 is a schematic diagram of an information configuration interface;

FIG. 2 is a flow chart of a method provided in an embodiment of the present invention;

FIG. 3 is a flow chart of another method provided in an embodiment of the present invention;

FIG. 4 is a schematic diagram of a rule tree provided in an embodiment of the present invention;

FIG. 5 is a schematic diagram of an information configuration interface provided in an embodiment of the present invention;

FIG. 6 is a schematic diagram of another information configuration interface provided in an embodiment of the present invention;

FIG. 7 is a schematic diagram of a device provided in an embodiment of the present invention; and

FIG. 8 is a schematic diagram of another device provided in an embodiment of the present invention.

### DETAILED DESCRIPTION OF THE EMBODIMENTS

To make the above objective, features, and advantages of the present invention more comprehensive, the following describes the present invention in detail with reference to the accompanying drawings and specific embodiments.

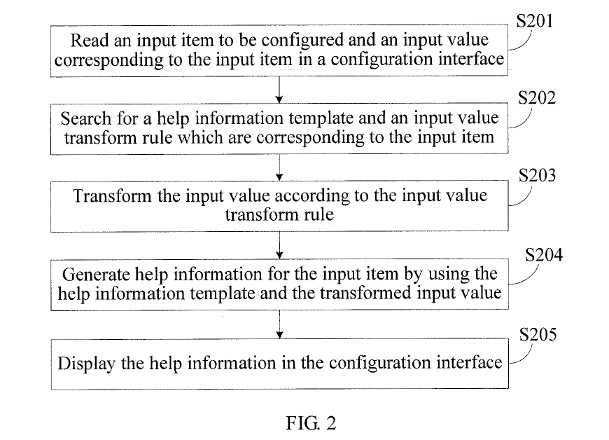

Referring to FIG. 2, an auxiliary method in an information configuration process provided in an embodiment of the present invention includes the following steps.

S201: Read an input item to be configured and an input value corresponding to the input item in a configuration interface.

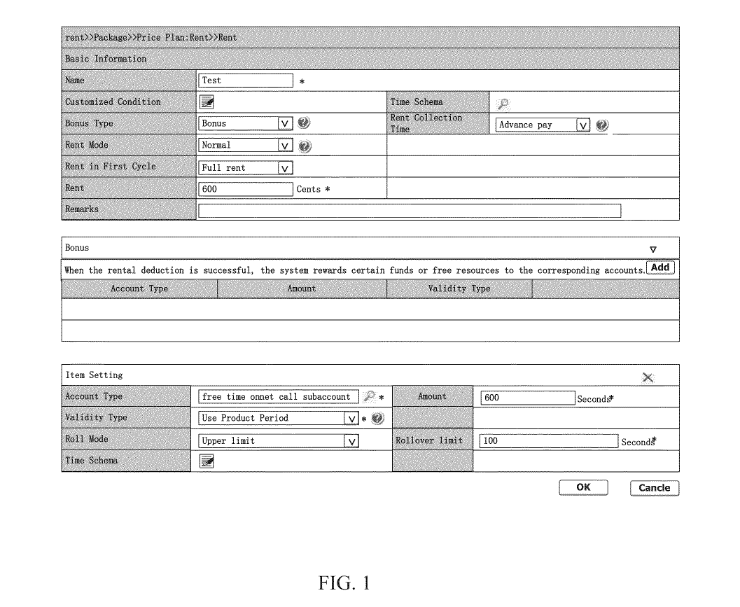

Referring to FIG. 1, an input item in the configuration interface may refer to a field name displayed before each input box, for example, “Bonus Type” (bonus type) and “Rent Mode” (rent mode) in FIG. 1. An input value is a specific value displayed in an input box corresponding to an input item. Generally, in an initial state (when the configuration interface is just opened), an input value may be a default input value and the input value can be modified. An information configuration process is equivalent to a process of modifying an input value corresponding to an input item. Definitely, in the initial state, the default input value may also be null and the information configuration process is equivalent to a process of providing a corresponding input value for an input item.

Therefore, reading the input item to be configured and the input value thereof may refer reading the input item and a default input value corresponding to the input item in the configuration interface in the initial state. Meanwhile, input of a user may be tracked and the read input value may also be an input value after being modified by the user.

The input item to be configured and the input value corresponding to the input item may be an input item on which a cursor or a mouse is positioned and an input value corresponding to the input item. For example, an input box is usually provided for each input item in the configuration interface and an input value corresponding to the input item is displayed in the input box thereof. When a user needs to configure an input value for a certain input item, the user needs to move the cursor into an input box corresponding to the input item first, and then inputs a required input value into the input box or replaces an original input value in the input box with the required input value. Therefore, in the embodiment of the present invention, a position of the cursor can be tracked and when the user positions the cursor into a certain input box, an input item corresponding to the input box and a current input value (may be null) of the input item can be read.

Definitely, in actual application, if the user just enters the configuration interface and has not determined which input item to configure, the user may merely moves a mouse pointer in the configuration interface and does not position the cursor into a certain input box. At this time, when the mouse pointer points to a certain input item or the area of a corresponding input box (for example, when the mouse pointer stays in the area) in the movement, the input item and an input value corresponding to the input item in this area may be read. When the mouse pointer points to another input item or the area of an input box corresponding to the input item, the another input item and an input value corresponding to the input item are read.

S202: Search for a help information template and an input value transform rule which are corresponding to the input item.

To provide help information for the input item and the input value corresponding to the input item, a configuration database may be set in advance in the embodiment of the present invention. The configuration database may contain the following information: meaning of a tag corresponding to each input item and a data type of data corresponding to each input item. Some data may require units of measurement. Therefore, configuration data may also contain an input value transform rule, which includes information such as the unit of measurement of the data.

In specific implementation, the above configuration data may be organized using a template. That is, a help information template is set for each input item. In this way, according to the help information template and the input value transform rule, meaning of a tag corresponding to the input item and meaning of the input value may be combined to generate help information for the input item.

The help information template may usually take the form of “meaning of an input item+default value of an input value” in which the meaning of the input item may be set in advance. For example, a help information template corresponding to an input item “Rent” may be “the monthly rental is + default value of an input value” (“+” in the template is not displayed in a display process).

Different input value transform rules can be set according to data types of input values. For example, a unit of data may be set in an input value transform rule for data of a numerical type. If unit conversion needs to be performed, a unit conversion rule may also be set. For example, it is assumed that an input value corresponding to an input item “Rent” (monthly rental) is data of a numerical type and the unit thereof in the configuration interface is usually “fen”, but a transformation result of the input value needs to take “yuan” as a unit. Therefore, in the input value transform rule, the unit of the data may be set as “yuan” and the unit conversion rule may be set as “input value/100”. In this way, in the specific conversion, a read input value may be first divided by 100 and the unit “yuan” may be placed after an obtained number. For another example, some input values may be of an enumerated data type. In this situation, an input value transform rule may be implemented in a manner of a mapping table or in other manners. That is, correspondence between various possible input values and respective transformation results is set in an input value transform rule for a certain input item. In this way, it only needs to directly query the mapping table during the transformation. For example, an input value of an input item “Bonus Type” (bonus type) in the configuration interface may be either “Bonus” or “No Bonus”. Therefore, the following correspondence may be set in the mapping table: “Bonus”->“a bonus exists”, “No Bonus”->“no bonus exists”. In this way, if the input value corresponding to the input item “Bonus Type” is read as “Bonus”, the “Bonus” may be transformed into “bonus exists” by querying the mapping table.

That is to say, each input item may correspond to its own help information template and input value transform rule in the configuration database. When a certain input item to be configured is read, a help information template and an input value transform rule corresponding to the input item may be found in the configuration database.

S203: Transform the input value according to the transform rule.

After the help information template and the input value transform rule which are corresponding to the input item are found, the current read input value may be transformed by using the input value transform rule. For example, an input value “600” corresponding to an input item “Rent” may be transformed into “6 yuan”.

S204: Generate help information for the input item by using the help information template and the transformed input value.

The help information template corresponding to the input item is obtained in advance and the input value is transformed in step S203. Therefore, the help information template and the transformed input value may be combined to obtain the help information for the input item. For example, if the help information template includes the meaning of the input item and the default value of the input value, the combining process is equivalent to a process of replacing the default value of the input value in the help information template with the transformed input value.

Specifically, it is assumed that an input item is “Rent” (monthly rental) and the corresponding input value is “600”. In the configuration data, meaning of a tag corresponding to “Rent” is “the monthly rental is”, a data type of the input value corresponding to the input item is the numerical type, a unit of measurement of the input value is “yuan”, and the corresponding template is “the monthly rental is + default value of an input value”. The input value transform rule is to divide the current value by 100 and take “yuan” as the unit. In the transformation of the input value, “600” is first transformed into “6 yuan” and “default value of an input value” is replaced with “6 yuan” according to the help information template. Therefore, help information “the monthly rental is 6 yuan” may be obtained, which is the help information for the input item “Rent”.

It should be noted that if the help information is provided when the user just enters the configuration interface, an input value corresponding to each input item in the configuration interface may be an initial default value. Therefore, a situation in which a default value is null may exist. At this time, in the transformation of the input value, the input value may be directly transformed into “ . . . ”. When being combined with the help information template, the default value of the input value may be replaced with “ . . . ”. After the user inputs a specific configuration value, the input value may also be the configuration value input by the user. Therefore, the input value may be the default value corresponding to the input item or the configuration value input by the user.

It should be noted in addition that the form “meaning of an input item+default value of an input value” may not be used in the help information template in actual application and other forms may also be used.

S205: Display the help information in the configuration interface.

The help information for the input item to be configured may be directly displayed in the configuration interface after being obtained. In this way, the user can directly see the meaning of both the input item to be configured and the input value corresponding to the input item in a help interface, thereby helping the user to complete the specific configuration process.

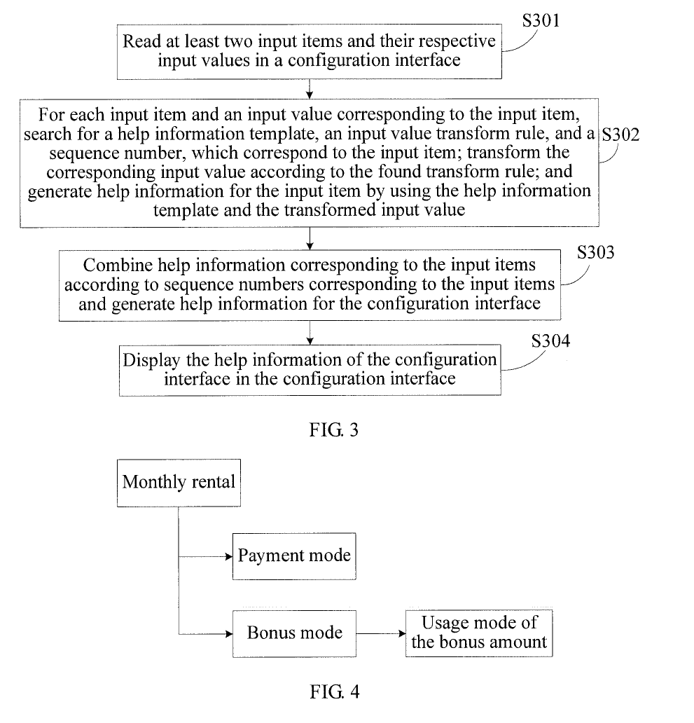

How to provide help information for one input item and the corresponding input value in the configuration interface is introduced in the above embodiment. However, in the actual application, multiple input items may exist in the configuration interface. Each input item corresponds to its own input value and the input items may be associated with each other, and the user needs to learn meaning of multiple input items and input values corresponding to the input items in the configuration interface. Therefore, an embodiment of the present invention provides another auxiliary method in an information configuration process, so as to provide the user with help information for the configuration interface (instead of a single input item). Referring to FIG. 3, the method includes the following steps.

S301: Read at least two input items and their respective input values in a configuration interface.

In the specific reading process, a current position of a mouse pointer or a cursor may not be considered. For example, all input items and their respective input values in the configuration interface may be directly read out and used as information to be transformed. Definitely, only a part of the input items and input values corresponding to the part of the input items in the configuration interface may be read.

S302: For each input item and an input value corresponding to the input item, search for a help information template, an input value transform rule, and a sequence number, which correspond to the input item; transform the corresponding input value according to the found transform rule; and generate help information for the input item by using the help information template and the transformed input value.

For each read input item and the input value corresponding to the input item, the preceding method may be used to obtain help information for each input item through transformation.

S303: Combine help information corresponding to the input items according to sequence numbers corresponding to the input items and generate help information for the configuration interface.

Because the help information for the input items is obtained, after being arranged according to the sequence numbers of the input items, the help information for the input items may form the help information for the configuration interface. For example, if the help information for one input item is one sentence, the help information for the configuration interface is a paragraph formed by arranging sentences in a specific order.

S304: Display the help information of the configuration interface in the configuration interface.

The help information for the configuration interface is finally displayed in the configuration interface, and the user can use the help information to configure information.

The sequence numbers of the input items can be obtained according to the sequence of the input items in the configuration interface. For example, in the configuration interface, the first input item is “Bonus Type” and the second input item is “Rent Mode”. During the arranging of the help information for the input items, help information for the input item “Bonus Type” is arranged in the first place and help information for the input item “Rent Mode” is placed next to the first place. The following arrangement can be obtained by analogy.

However, in actual application, the help information formed by arranging the help information for the input items in the sequence of the input items in the configuration interface may have relatively poor coherence and does not comply with codes of human languages. Therefore, if the help information for the input items can be arranged according to a syntax rule, meaning of the input items and the input values in the current configuration interface can be more easily and directly understood intuitively. For example, a bonus is followed by the amount of the bonus, a discount is followed by a discount percentage, and the monthly rental is followed by a payment mode. In this way, the help information can be smoother and comply with the reading habit of a target language. Therefore, in the embodiment of the present invention, the sequence numbers of the input items can be provided in configuration data. After the help information for the input items are obtained, the help information for the input items can be first arranged according to the sequence numbers in the configuration data, so that the sentences can be arranged to form one or more smooth and coherent paragraphs.

The above arrangement can be implemented in multiple modes. For example, in one mode, a rule tree may be set in advance in the configuration data according to a display sequence of the input items. That is, the input items can be organized according to the syntax rule to form a rule tree (multiple rule trees may exist). In the rule tree, a root node may be served as an input item corresponding to help information expressed in the first sentence of a paragraph. One root node may have multiple-level child nodes. Multiple nodes may act as child nodes at each level. The sequential relationship among the help information can be embodied by the relationship among parent nodes and child nodes in the rule tree. The parent nodes and the child nodes are the input items corresponding to the help information. For example, the “monthly rental” may be used as the first sentence of the paragraph. The “monthly rental” can be followed by the “payment mode” and can also be followed by the “bonus mode”. The bonus mode can be followed by the “usage mode of the bonus amount”. In a rule tree shown in FIG. 4, a root node is the “monthly rental” and first level child nodes thereof include the “payment mode” and the “bonus mode”. For each first level child node, if it is stilled followed by help information, an input item corresponding to the help information is used as a child node of the first level child node. The rest may be obtained by analogy. For example, the “usage mode of the bonus amount” becomes a child node of the “bonus mode”.

In this way, when a display sequence of the help information for the input items needs to be determined specifically, the display sequence of the help information can be determined according to positions of the input items in the rule tree. For example, multiple pieces of help information for input items are obtained through transformation, which include help information “the monthly rental is 6 yuan” corresponding to the input item “Rent” and help information “payment before usage” corresponding to “Rent Type”. According to the rule tree in the preceding example, positions of “Rent”, “Rent Type” and the like in the rule tree can be found first. It is found that “Rent” is the root node of the rule tree, so a corresponding sequence number may be 1 and the corresponding help information “the monthly rental is 6 yuan” is used as the first sentence of a paragraph. Next, a first level child node can be found in the rule tree using “Rent” as the root node. It is found that “Rent Type” is one of the first level child nodes of “Rent”, so a sequence number of “Rent Type” can be determined as 2 and “payment before usage” is displayed after “the monthly rental is 6 yuan”. Next, which input items are next-level child nodes of “Rent Type” is found, so as to determine which piece of help information is displayed next. The rest is displayed by analogy.

It should be noted that multiple child nodes may exist at the same level in the rule tree. Therefore, when help information is generated for input items in a certain configuration interface, multiple input items may exist at the same level of child nodes. For example, they can be identified as a first child node and a second child node according to a sequence thereof. In this situation, levels of child nodes of the first child node may be first numbered in sequence. That is, after pieces of help information for the levels of child nodes of the first child node are combined, pieces of help information for levels of child nodes of the second child node can be combined.

For example, when pieces of help information are combined according to the rule tree shown in FIG. 4, a sequence of the pieces of help information may be: {<“the monthly rental is 6 yuan”>, <“payment before usage”>, <“a bonus exists”>, <“the bonus amount is available all day”>}.

As can be seen, the help information for the configuration interface can be displayed in the configuration interface in the above mode, so as to display meaning of each input item and an input value corresponding to the input item in the configuration interface intuitively, thereby providing help for a user in information configuration.

In the preceding situation where the help information is provided for multiple input items in the configuration interface, in the embodiment of the present invention, to further help the user to learn meaning of each input item, help information corresponding to an input item can be displayed distinguishably from other help information when the user moves the mouse pointer to the input item or the area of an input box thereof, or positions the cursor into the input box of the input item, or selects the input item by clicking and dragging the mouse to enclose it in a box. For example, the help information can be highlighted, or a font color of the help information can be changed. For example, when the user clicks the mouse on the input box of a certain input item, help information corresponding to the input item may be highlighted to prompt meaning of the input item corresponding to the current input value. In this way, the user can learn intuitively whether the input item is the input item to be configured, which value needs to be configured for the input item, and the like.

In specific implementation, each input item has its own sequence number. Therefore, if help information corresponding to an input item selected by the user or corresponding to an input item on which the mouse is clicked needs to be displayed distinguishably, the input item needs to be determined first, and then a position of the help information, which is corresponding to the input item, in the help information for the configuration interface is found according to the sequence number of the input item. Finally, the help information at this position is displayed distinguishably. For example, the input item selected by the user is “Rent” and the sequence number of the input item can be obtained, where the sequence number is assumed as 2. In this way, the second sentence in the help information for the configuration interface is displayed distinguishably.

Definitely, the user may select multiple input items at the same time and help information corresponding to the input items selected by the user can also be displayed distinguishably. The specific method is similar to the method used when one input item is selected, which is not described herein again.

Besides, when the user configures an input item in the configuration interface, an input value corresponding to the input item may be changed. For example, an original input value of the input item “Rent” is “600” and the user modifies the original input value into “500”. At this time, the help information for the input item changes, and correspondingly, the help information for the configuration interface should also change along with the help information for the input item.

For the above situation, input of the user can be tracked in the embodiment of the present invention. When the user modifies an input value for a certain input item, for example, when the user inputs a value into a field and moves cursor focus away from the input box of the field, the input item and the modified input value can be reread, transformation is performed to regenerate help information for the input item. Meanwhile, the sequence number of the input item is obtained and a position of the help information for the input item in the help information for the configuration interface is found. Afterward, the help information at this position in the help information for the configuration interface is replaced with the regenerated help information for the input item. For example, the original input value of the input item “Rent” is “600” and the help information corresponding thereto is “the monthly rental is 6 yuan”. The user modifies the original input value into “500” in a configuration process and the regenerated help information is “the monthly rental is 5 yuan” and needs to be displayed in the configuration interface. At this time, the sequence number corresponding to the input item “Rent” may be obtained, and the sequence number is assumed as 2, and then the second piece of help information in the help information for the configuration interface is replaced with “the monthly rental is 5 yuan”.

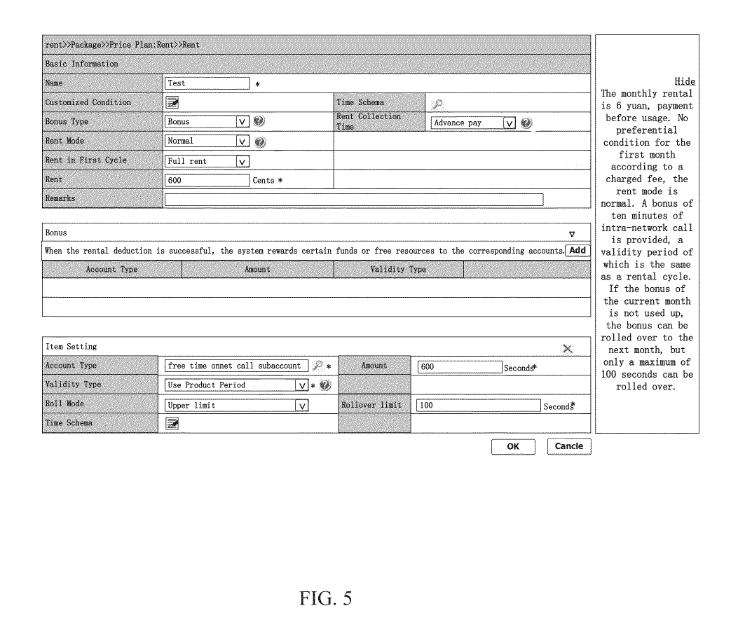

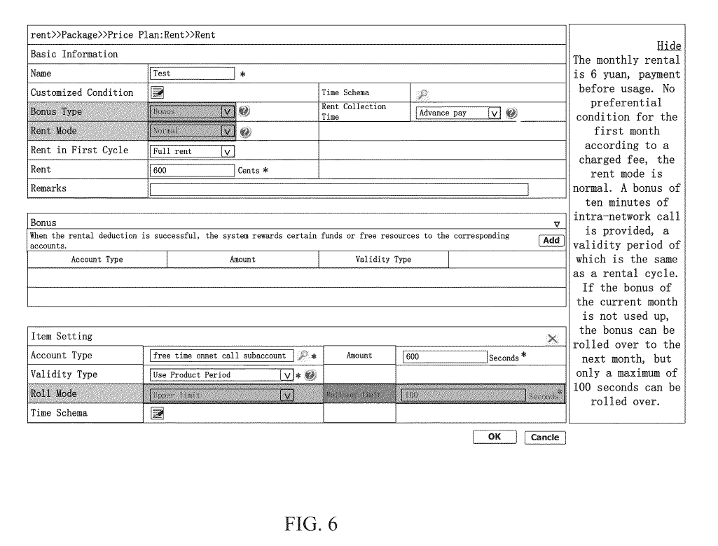

It should be noted that when help information for a certain input item or help information for the configuration interface is displayed in the configuration interface, there are multiple specific implementation manners. For example, as shown in FIG. 5, the help information can be displayed in the right side area of the configuration interface. Correspondingly, in a situation where the help information for the configuration interface is displayed, when help information corresponding to a certain input item or some input items needs to be displayed in highlight, as shown in FIG. 6, it is assumed that the user selects three input items “Bonus Type”, “Rent Mode”, and “Roll Mode”, help information corresponding to these input items is displayed prominently in the help information displayed on the right side, where the help information corresponding to these input items is as follows: “no preferential condition for the first month according to a charged fee”, “the rent mode is normal”, and “if the bonus of the current month is not used up, the bonus can be rolled over to the next month, but only a maximum of 100 seconds can be rolled over”. Definitely, in the actual application, help information can be displayed in other modes, for example, the mode of a pop-up window can be used. The modes are not described herein again.

It should be noted in addition that the auxiliary method in an information configuration process in the embodiment of the present invention can be independently accomplished by a client or can be accomplished by the client in cooperation with a server. In the former situation, the client directly reads an input item and an input value of the input item in the configuration interface and then performs transformation according to the configuration data. In the latter situation, after the client reads an input item and an input value corresponding to the input item, the input item and the input value corresponding to the input item are sent to the server. The server performs transformation on the input item and the input value corresponding to the input item and then returns a transformation result to the client for displaying.

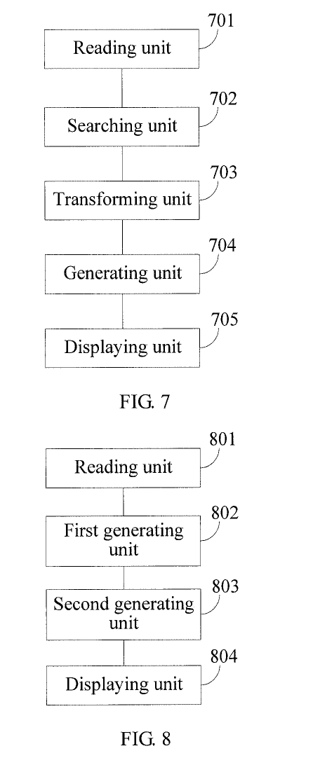

Corresponding to the auxiliary method in an information configuration process provided in the embodiment of the present invention, an embodiment of the present invention also provides an auxiliary device in an information configuration process. Referring to FIG. 7, the device includes a reading unit 701, a searching unit 702, a transforming unit 703, a generating unit 704, and a displaying unit 705.

The reading unit 701 is configured to read an input item to be configured and an input value corresponding to the input item in a configuration interface.

In the specific implementation process, the reading unit 701 may further include a processor. The processor is configured to read the input item to be configured and the input value corresponding to the input item in the configuration interface.

The searching unit 702 is configured to search for a help information template and an input value transform rule which are corresponding to the input item.

In the specific implementation process, the searching unit 702 may further include a processor. The processor is configured to search for the help information template and the input value transform rule which are corresponding to the input item.

The transforming unit 703 is configured to transform the input value according to the input value transform rule.

In the specific implementation process, the transfot ning unit 703 may further include a processor. The processor is configured to transform the input value according to the input value transform rule.

The generating unit 704 is configured to generate help information for the input item by using the help information template and the transformed input value.

In the specific implementation process, the generating unit 704 may further include a processor. The processor is configured to generate the help information for the input item by using the help information template and the transformed input value.

The displaying unit 705 is configured to display the help information in the configuration interface.

In the specific implementation process, the displaying unit 705 may further include a processor. The processor is configured to display the help information in the configuration interface.

The help information template may take the form of “meaning of an input item+default value of an input value”. At this time, the generating unit 704 may be specifically configured to replace a default value in the help information template with the transformed input value and determine the help information template after the replacement as the help information for the input item. In the specific implementation, during the reading of the input value corresponding to the input item, the input value may be the default value corresponding to the input item in an initial state and may also be a configuration value input into a corresponding input box after a user configures the input item.

In the embodiment of the present invention, help information can be provided for a certain input item and an input value corresponding to the input item in the configuration interface through the above device. In this way, in the information configuration process, the user can directly learn meaning of each input item and a current input value corresponding to the input item according to the help information displayed in the configuration interface without the need of switching to a help interface to search for the help information, thereby improving the efficiency of information configuration.

In addition to providing help information for a certain input item and an input value corresponding to the input item, in an embodiment of the present invention, help information can also be provided for multiple input items and their respective input values in the configuration interface. Correspondingly, an embodiment of the present invention also provides another auxiliary device in an information configuration process. Referring to FIG. 8, the device includes a reading unit 801, a first generating unit 802, a second generating unit 803, and a displaying unit 804.

The reading unit 801 is configured to read at least two input items and their respective input values in a configuration interface.

In the specific implementation process, the reading unit 801 may further include a processor. The processor is configured to read the at least two input items and their respective input values in the configuration interface.

The first generating unit 802 is configured to, for each input item and an input value corresponding to the input item, search for a help information template, an input value transform rule, and a sequence number, which correspond to the input item; transform the corresponding input value according to the found transform rule; and generate help information for the input item by using the help information template and the transformed input value.

In the specific implementation process, the first generating unit 802 may further include a processor. The processor is configured to, for each input item and the input value corresponding to the input item, search for the help information template, the input value transform rule, and the sequence number, which correspond to the input item; transform the corresponding input value according to the found transform rule; and generate the help information for the input item by using the help information template and the transformed input value.

The second generating unit 803 is configured to combine help information corresponding to the input items according to sequence numbers corresponding to the input items and generate help information for the configuration interface.

In the specific implementation process, the second generating unit 803 may further include a processor. The processor is configured to combine the help information corresponding to the input items according to the sequence numbers corresponding to the input items and generate the help information for the configuration interface.

The displaying unit 804 is configured to display the help information of the configuration interface in the configuration interface.

In the specific implementation process, the displaying unit 804 may further include a processor. The processor is configured to display the help information of the configuration interface in the configuration interface.

Likewise, the help information template may take the form of “meaning of an input item+default value of an input value”. At this time, the first generating unit 802 can be specifically configured to replace the default value in the help information template with the transformed input value and determine the help information template after replacement as the help information for the input item.

If a user configures a certain input item in the configuration interface, a corresponding input value may change. At this time, the help information for the configuration interface can be correspondingly modified in the embodiment of the present invention. Therefore, the first generating unit 802 is further configured to, after it is detected that the user modifies the input value of any one of the at least two input items, regenerate help information for the input item. It is not difficult to understand that the above function of the first generating unit 802 can still be implemented by the processor included in the first generating unit 802. The device shown in FIG. 8 may also include a position determining unit and a replacing unit.

The position determining unit is configured to determine a position of the help information for the input item in the help information for the configuration interface according to a sequence number of the input item.

In the specific implementation process, the position determining unit may further include a processor. The processor is configured to determine the position of the help information for the input item in the help information for the configuration interface according to the sequence number of the input item.

The replacing unit is configured to replace the help information at the position with the regenerated help information for the input item.

In the specific implementation process, the replacing unit may further include a processor. The processor is configured to replace the help information at the position with the regenerated help information for the input item.

In the help information for the configuration interface, the help information for the input items is organized into one or more paragraphs according to the sequence numbers of the input items. However, the sequence numbers may be inconsistent with the positions of the input items in the configuration interface. Therefore, to enable the user to learn the help information corresponding to each input item, when the user selects a certain input item or positions a cursor at the input item, help information for the input item may be highlighted. At this time, the device may further include a highlighting unit.

The highlighting unit is configured to highlight help information corresponding to an input item, which is pointed to, in the help information for the configuration interface when an operation of pointing to one of the at least two input items is detected.

In the specific implementation process, the highlighting unit may further include a processor. The processor is configured to highlight the help information corresponding to the input item, which is pointed to, in the help information for the configuration interface when the operation of pointing to one of the at least two input items is detected.

In the embodiment of the present invention, help information can be provided for multiple input items and their respective input values in the configuration interface through the above device. In this way, in the information configuration process, the user can directly learn meaning of each input item and a current input value corresponding to the input item according to the help information displayed in the configuration interface without the need of switching to a help interface to search for the help information, thereby improving the efficiency of information configuration.

Persons of ordinary skill in the art should understand that all or a part of the steps of the method according to the embodiments of the present invention may be implemented by a program instructing relevant hardware. The program may be stored in a computer readable storage medium. When the program runs, the following steps are included: reading an input item to be configured and an input value corresponding to the input item in a configuration interface; searching for a help information template and an input value transform rule which are corresponding to the input item; transform the input value according to the input value transform rule; generate help information for the input item by using the help information template and the transformed input value; and displaying the help information in the configuration interface. Alternatively, when the program runs, the following steps are included: reading at least two input items and their respective input values in a configuration interface; for each input item and an input value corresponding to the input item, searching for a help information template, an input value transform rule, and a sequence number, which correspond to the input item; transforming the corresponding input value according to the found transform rule; generating help information for the input item by using the help information template and the transformed input value; combining help information corresponding to the input items according to sequence numbers corresponding to the input items and generating help information for the configuration interface; and displaying the help information of the configuration interface in the configuration interface. The storage medium may be a ROM/RAM, a magnetic disk, an optical disk, or the like.

The auxiliary method and the auxiliary device in an information configuration process provided by the present invention are introduced in detail above. The principle and implementation of the present invention are described herein through specific examples. The above embodiments are merely illustrated to help understand the method and core idea of the present invention. Meanwhile, persons of ordinary skill in the art can make variations to the present invention in terms of the specific implementation and application scope according to the idea of the present invention. In conclusion, the content of the specification shall not be understood as a limitation to the present invention.

What is claimed is:

1. An auxiliary method in an information configuration process, comprising:
reading an input item to be configured and an input value corresponding to the input item in a configuration interface;
searching for a help information template and an input value transform rule which are corresponding to the input item;
transforming the input value according to the input value transform rule;
generating help information for the input item by using the help information template and the transformed input value; and
displaying the help information in the configuration interface.

2. The method according to claim 1, wherein the generating the help information for the input item by using the help information template and the transformed input value comprises:
replacing a default value in the help information template with the transformed input value and determining a help information template with the transformed input value after replacement as the help information for the input item.

3. The method according to claim 1 wherein the input value comprises a default value corresponding to the input item or a configuration value input by a user.

4. An auxiliary method in an information configuration process, comprising:
reading at least two input items and their respective input values in a configuration interface;
for each input item and the input value corresponding to the input item, searching for a help information template, an input value transform rule, and a sequence number, which correspond to the input item; transforming the corresponding input value according to the found transform rule; and generating help information for the input item by using the help information template and the transformed input value;
combining help information corresponding to the input items according to sequence numbers corresponding to the input items and generating help information for the configuration interface; and
displaying the help information of the configuration interface in the configuration interface.

5. The method according to claim 4, wherein the generating the help information for the input item by using the help information template and the transformed input value comprises:
replacing a default value in the help information template with the transformed input value and determining a help information template with the transformed input value after replacement as the help information for the input item.

6. The method according to claim 4, further comprising:
after detecting that a user modifies an input value of any one of the at least two input items, regenerating help information for the input item;
determining a position of the help information for the input item in the help information for the configuration interface according to a sequence number of the input item; and
replacing the help information at the position with the regenerated help information for the input item.

7. The method according to claim 4, further comprising:
highlighting help information corresponding to an input item, which is pointed to, in the help information for the configuration interface when an operation of pointing to one of the at least two input items is detected.

8. An auxiliary device in an information configuration process, comprising:
a reading unit, configured to read an input item to be configured and an input value corresponding to the input item in a configuration interface;
a searching unit, configured to search for a help information template and an input value transform rule which are corresponding to the input item;
a transforming unit, configured to transform the input value according to the input value transform rule;
a generating unit, configured to generate help information for the input item by using the help information template and the transformed input value; and
a displaying unit, configured to display the help information in the configuration interface.

9. The device according to claim 8, wherein the generating unit is specifically configured to replace a default value in the help information template with the transformed input value and determine a help information template with the transformed input value after replacement as the help information for the input item.

10. The device according to claim 8, wherein the input value comprises a default value corresponding to the input item or a configuration value input by a user.

11. An auxiliary device in an information configuration process, comprising:
a reading unit, configured to read at least two input items and their respective input values in a configuration interface;
a first generating unit, configured to, for each input item and the input value corresponding to the input item, search for a help information template, an input value transform rule, and a sequence number, which correspond to the input item; transform the corresponding input value according to the found transform rule; and generate help information for the input item by using the help information template and the transformed input value;
a second generating unit, configured to combine help information corresponding to the input items according to sequence numbers corresponding to the input items and generate help information for the configuration interface; and
a displaying unit, configured to display the help information of the configuration interface in the configuration interface.

12. The device according to claim 11, wherein the first generating unit is specifically configured to replace a default value in the help information template with the transformed input value and determine a help information template with the transformed input value after replacement as the help information for the input item.

13. The device according to claim 11, wherein the first generating unit is further configured to, after it is detected that a user modifies an input value of any one of the at least two input items, regenerate help information for the input item;
the device further comprising:
a position determining unit, configured to determine a position of the help information for the input item in the help information for the configuration interface according to a sequence number of the input item; and
a replacing unit, configured to replace the help information at the position with the regenerated help information for the input item.

14. The device according to claim 11, further comprising:
a highlighting unit, configured to highlight help information corresponding to an input item, which is pointed to, in the help information for the configuration interface when an operation of pointing to one of the at least two input items is detected.
